(19) United States
(12) Patent Application Publication
(10) Pub. No.: US 2009/0210745 A1
(43) Pub. Date: Aug. 20, 2009

(54) Runtime Error Correlation Learning and Guided Automatic Recovery

(76) Inventors: Sherilyn M. Becker, Waterloo, IA (US); Wei Hu, Middleton, WI (US); Brad W. Pokorny, Rochester, MN (US); Jun C. Yin, Rochester, MN (US)

Correspondence Address: IBM CORPORATION, 3605 HIGHWAY 52 NORTH, DEPT. 917, BUILDING 006-1, ROCHESTER, MN, 55901-7829, US

(21) Appl. No.: 12/030,949

(22) Filed: Feb. 14, 2008

(51) Int. Cl. G06F 11/00

(52) U.S. Cl. 714/26; 714/E11.001

(57) ABSTRACT

A method and apparatus for automatic error analysis and recovery for applications on one or more computer systems, which maintain a dependency structure of the applications, maintain correlation information between errors and error symptoms, and analyze and recover a problem when the problem occurs. The method, program product or system further utilizes a centralized knowledge base for runtime error handling and problem resolution.

### BACKGROUND

1. Technical Field

The present invention relates to automatic error correlation analysis. More specifically, it relates a method and system for system-maintained runtime error correlation learning and guided automatic recovery.

2. Background Information

A computer system may have multiple applications running at the same time. When multiple errors occur in such a computer system, the customers report problems to the support team. The support team then works on each individual problem and gets back to the customer. Hence, the turnaround of each problem solving process is slow, and multiple passes are usually required to solve all problems.

There has been research done to try to correlate errors, log events and symptoms that occur from different sources for better problem determination. The goal is to find the root causes of a set of problems more efficiently as well as to give the user the best automated or guided recovery. This will save cost from both customer and vendor ends.

Among the existing solutions, some manually define and ship correlation rules for a set of symptoms based on past experience and feedback from the customer support. Some other solutions manually define and ship the correlation rules for a certain pattern of symptoms occurring during a defined time window based on past experience and feedback from customer support. However, the set of manually defined rules in these solutions only covers a portion, usually a selected important portion, of correlated symptoms. Also, extra maintenance is required in addition to the symptom catalog updates when the application version changes.

Some existing solutions dynamically correlate events only according to maintained statistics of co-occurrence between errors and symptoms. Although this approach is more flexible than the methods using manually defined rules, the co-occurrence can sometimes be misleading. Even though some error events may often happen together, their sources (applications) may have no dependency at all. The build-up of the table capturing co-occurrence is also slower, given the fact that a longer period is needed to collect usable statistics.

Some solutions maintain centralized logging with call stack order integrated such that errors are layered automatically with no correlation needed. However, centralized logging is mostly limited to one vendor condition when the logging on the whole system is well controlled and organized. This solution cannot be applied generically as most systems have applications from different vendors installed and interacting with each other.

A more general approach is postmortem analysis with a correlation tool against a collected set of logs to show tree-structured symptoms. Postmortem analysis has similar requirements in correlation rules to other solutions. Turnaround of problem determination and solving takes longer with this approach.

Yet other solutions create a model of the system being monitored and use this model to analyze problems. However, accurate modeling of complex systems is nearly impossible in practice, because the size of the model becomes unmanageable.

Overall, no cost-efficient way is known in the prior art to provide the customers with all possible error correlations among a variety of applications in a short period.

### SUMMARY

A method, computer program product and computer system for automatic error analysis and recovery for applications on one or more computer systems, which maintain a dependency structure of the applications, maintain correlation information between errors and error symptoms, and analyze and recover a problem when the problem occurs. The method, program product and system further utilize a centralized knowledge base for runtime error handling and problem resolution.

### BRIEF DESCRIPTION OF DRAWINGS

FIG. 1 is a diagram of an application dependency tree of a single system.

FIG. 2 is a diagram of an application dependency tree of a distributed system.

FIG. 3 is a diagram of an application dependency tree showing the nodes with errors.

FIG. 4 is a diagram of the application error tree of FIG. 3.

FIG. 5 is a diagram of the updated application error tree of FIG. 4.

FIG. 6 is a conceptual diagram of a computer system that can utilize the present invention.

### DETAILED DESCRIPTION

The invention will now be described in more detail by way of example with reference to the embodiments shown in the accompanying Figures. It should be kept in mind that the following described embodiments are only presented by way of example and should not be construed as limiting the inventive concept to any particular physical configuration. Further, if used and unless otherwise stated, the terms “upper,” “lower,” “front,” “back,” “over,” “under,” and similar such terms are not to be construed as limiting the invention to a particular orientation. Instead, these terms are used only on a relative basis.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable media may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention generates self-learning correlation rules for automatic recovery, and utilizes a centralized knowledge base for optimal error handling and problem resolution during runtime.

In one embodiment of the present invention, an error correlation table (ECT) is maintained on the customer's system, based on the symptom catalogs for supported serviceable applications. When a supported application is installed, updated, or uninstalled, corresponding correlation entries of the application in the ECT are updated by the system. The system also maintains an application dependency structure, given that the module calling dependencies are extractable from the system software management. Error occurrence thus enables the self-learning to build up the correlation knowledge, based specifically on the application dependency structure. With the system-maintained, self-learning and host-system-specific ECT, runtime log monitoring can quickly sense the occurrence of a problem (or a set of problems) and generate the call dependency based error symptom tree as soon as enough (e.g. when reaching a predetermined number) error events are logged to determine the problem. At the same time the error symptom tree is generated, the recovery steps (either from automatic scripts, manual instructions or a combination of the two) could be built bottom-up starting from the root cause problem. In most cases, fixing the root cause problem will solve all upstream problems. A counter of hits for each correlation is also maintained. The counter will be set to zero if a false positive correlation entry is found, which will then be kept to prevent repeat checks.

When a customer system communicates with the service center for an application during the installation or un-installation, problem reporting or updating process, the correlation entries related with this application can be shared. That is, the new learned correlation rules that are not found in the correlation knowledge base in the support center of the application, either false positive or positive, are added to the knowledge base, and the new rules in the knowledge base are added to the system's error correlation table. The scope of this sharing can be set to a single system (i.e. no sharing), a set of systems, or a vendor's centralized correlation rule knowledge base.

In the present invention, the system maintains application dependency structure, and collects and distributes the error correlation rules automatically. The correlation rules are learned quickly, with no manual intervention required to define rules or correlation patterns. A centralized knowledge base enables the quick learning and sharing of the correlation rules and facilitates their application to error handling. Analysis information of the reported errors can thus be obtained at runtime, and is immediately available after a problem is detected.

In one embodiment of the present invention, an Application Dependency Tree (ADT), a non-circular directed tree in which a node representing an application points to the nodes it depends on, is created to keep the application dependency structure of a system. During the install, uninstall and updates on the system, the immediate dependencies among applications are maintained in the ADT. The initial application dependencies are built up during system install. During system uninstall or update, the ADT is changed. The nodes in the ADT are primarily software, but at the very bottom of the tree (where the top and bottom are in accordance with the head and tail of edges in the directed tree) there could be hardware type of dependency nodes to indicate the fundamental basics of system functionality. Failure of those nodes is almost certain to cause pervasive system-wide application failures. These nodes are especially useful or applicable to systems containing distributed hardware modules.

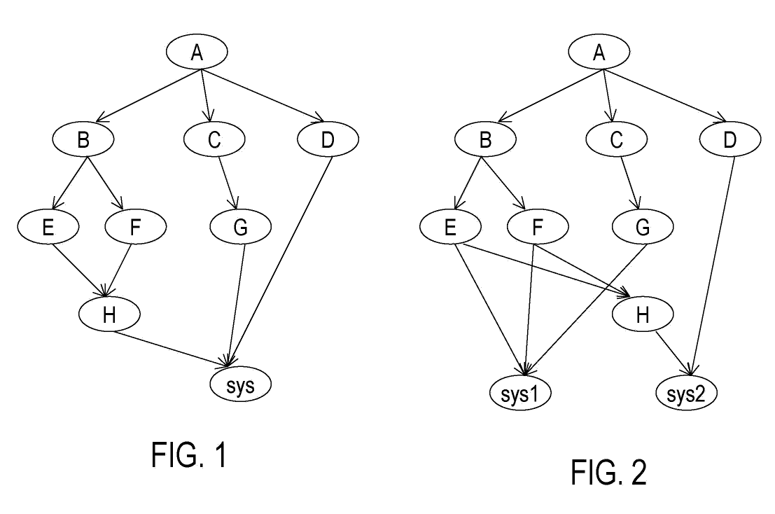

FIG. 1 and FIG. 2 illustrate examples of ADTs. FIG. 1 shows the ADT of a single system, wherein application A depends on applications B, C and D, application B depends on applications E and F, applications E and F both depend on application H, application C depends on application G, and all applications depend on the fundamental working status (such as power on) of the system. FIG. 2 shows the ADT of a distributed system. In FIG. 2, applications are distributed on two systems. When application E and F are dependent on the local functioning system sys1, they are also dependent on application H (e.g. a HTTP server) and sys2 that hosts application H.

An Error Correlation Table (ECT) is created to save known error correlation rules for a system. The ECT acquires the error correlation rules via install distribution, updates from vendors, and learned error correlations rules from local system at runtime. Each ECT is then sent back to the vendor's knowledge base to be shared as an Error Correlation Knowledge Base (ECKB). Possible fields in an ECT or an Error Correlation Knowledge Base (ECKB) can be, but are not limited to:
Dependent application (with version)|Dependent symptom(s)|Dependentee application (with version)|Dependentee symptom(s)|Confidence factor (counter).
   For example, “A|a100|B|b200|3” means that when a100 and b200 both occur, solving error b200 for application B will help solve error a100 for application A, which, in practice, happened 3 times. The confidence factor counts occurrences of an error correlation. When a false positive occurrence is detected showing the rule is not valid, the count in the ECT is set to zero and reported to the ECKB. Every time a new correlation rule is found, it is also reported to the ECKB. If the count of the correlation rule in the ECT is higher than the count stored in the ECKB (unless the ECKB shows zero, i. e. false positive) for a matching rule, the ECKB's counter is updated to match the local counter. When the ECKB shares a new rule with a local ECT, it copies the counter value from the ECKB to the local ECT.

The ADTs and ECTs are maintained when an application changes. For an application X, when the application is installed, a new node X, dependency of X, and the immediate dependentees of X are added to the ADT. Correlation rules are downloaded from the ECKB of application X. When X is updated, new correlation rules are retrieved from the ECKB of application X and the counter in the ECKB is updated if the local ECT count is bigger. When X is removed, node X is removed from the ADT, if dependency allows. The ECKB is updated if needed with local ECT entries for application X. Local correlation rules are removed for application X from the ECT. When X is upgraded, node X is identified as new version information. Old ECT entries are removed and new ECT entries are downloaded for application X.

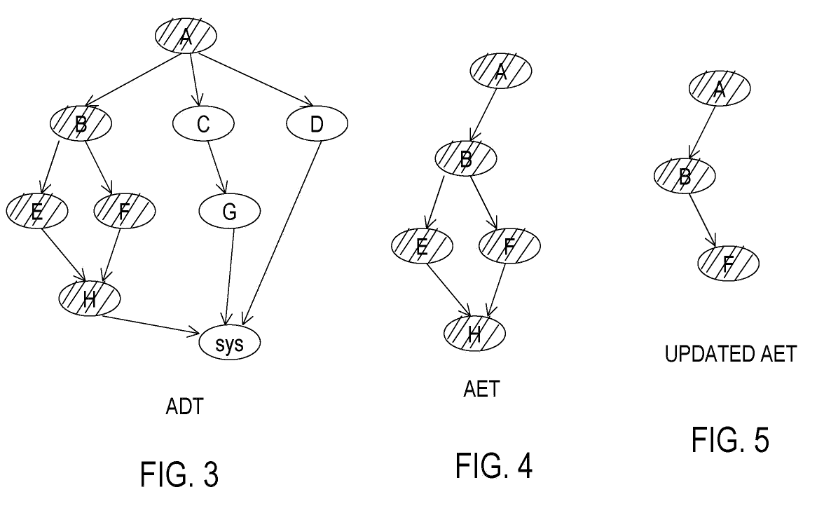

The following example demonstrates the error correlation rule learning, automatic error recovery, and central ECKB updating when some nodes have errors (which are shown as cross-hatching nodes in FIG. 3, FIG. 4 and FIG. 5) are detected. Application errors are monitored during runtime. Once errors occur in a defined time window, a corresponding Application Error Tree (AET) is identified in the ADT. In this example, there are nodes A-H and a system node with a dependency structure, as shown in FIG. 3. If xn is used to denote an error (with error id n) found in node X, it is assumed that the errors detected are a1, b2, b5, e3, f8 and h1. FIG. 4 shows the AET of the example. Known correlation rules associated with those errors are then checked, new findings are inserted, and old counters are updated, if the ECT currently has those rules. The current correlation rules are assumed to be: E|e3|H|h3|1;B|b2|E|e3|6.

From the AET one single leaf node H with an error h1 (that is the potential root cause) is identified. A bottom-up problem recovery sequence starting from the deepest leaf node in the AET is then started, and the recovering result is validated. Here it starts the recovery from node H's error h1. h1, e3 & b2 are assumed to be fixed during recovery steps, and other errors still remain. The ECT is now updated to: E|e3|H|h3|1;B|b2|E|e3|7;E|e3|H|h1|1.

The updated AET is shown in FIG. 5. Now F becomes the leaf node. If the recovery step is repeated for F with error f8, and all errors are resolved, the ECT is then updated to look like: E|e3|H|h3|1;B|b2|E|e3|7;E|e3|H|h1|1;B|b5|F|f8|1; A|a1|B|b5|1. The new entries are reported to the ECKB for application A, B, E, F, H, correspondingly.

Suppose errors e3 and h3 occur later on the same system, and the recovery steps of h3 cannot fix e3 this time, this indicates a false positive rule showing that when e3 and h3 happens together, solving h3 is not necessary to help solve e3. Thus, its ECT entry is updated to a count of 0 and reported to the ECKB right away, i.e. the entry becomes E|e3|H|h3|0.

The known correlation rules can be referenced during root cause analysis to optimize a quicker recovery of errors.

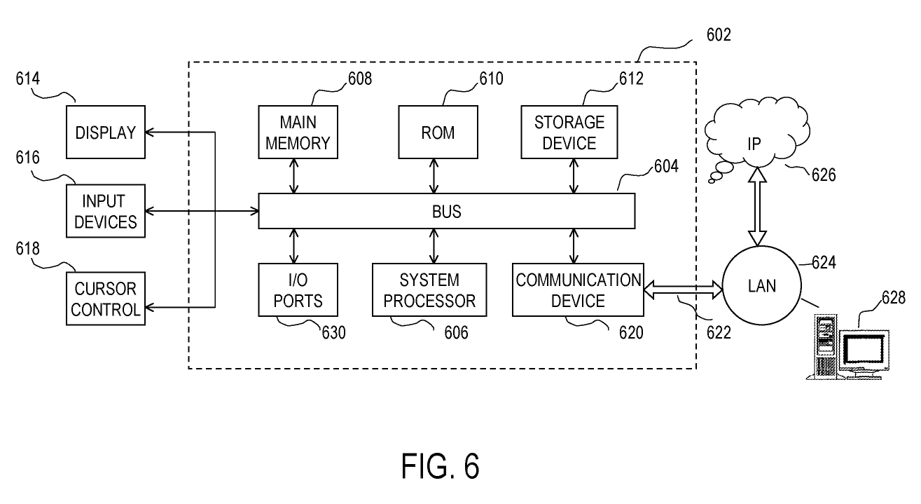

FIG. 6 illustrates a computer system (602) upon which the present invention may be implemented. The computer system may be any one of a personal computer system, a work station computer system, a lap top computer system, an embedded controller system, a microprocessor-based system, a digital signal processor-based system, a hand held device system, a personal digital assistant (PDA) system, a wireless system, a wireless networking system, etc. The computer system includes a bus (604) or other communication mechanism for communicating information and a processor (606) coupled with bus (604) for processing the information. The computer system also includes a main memory, such as a random access memory (RAM) or other dynamic storage device (e.g., dynamic RAM (DRAM), static RAM (SRAM), synchronous DRAM (SDRAM), flash RAM), coupled to bus for storing information and instructions to be executed by processor (606). In addition, main memory (608) may be used for storing temporary variables or other intermediate information during execution of instructions to be executed by processor. The computer system further includes a read only memory (ROM) 610 or other static storage device (e.g., programmable ROM (PROM), erasable PROM (EPROM), and electrically erasable PROM (EEPROM)) coupled to bus 604 for storing static information and instructions for processor. A storage device (612), such as a magnetic disk or optical disk, is provided and coupled to bus for storing information and instructions. This storage device is an example of a computer readable medium.

The computer system also includes input/output ports (630) to input signals to couple the computer system. Such coupling may include direct electrical connections, wireless connections, networked connections, etc., for implementing automatic control functions, remote control functions, etc. Suitable interface cards may be installed to provide the necessary functions and signal levels.

The computer system may also include special purpose logic devices (e.g., application specific integrated circuits (ASICs)) or configurable logic devices (e.g., generic array of logic (GAL) or re-programmable field programmable gate arrays (FPGAs)), which may be employed to replace the functions of any part or all of the method as described with reference to FIG. 1-FIG. 5. Other removable media devices (e.g., a compact disc, a tape, and a removable magneto-optical media) or fixed, high-density media drives, may be added to the computer system using an appropriate device bus (e.g., a small computer system interface (SCSI) bus, an enhanced integrated device electronics (IDE) bus, or an ultra-direct memory access (DMA) bus). The computer system may additionally include a compact disc reader, a compact disc reader-writer unit, or a compact disc jukebox, each of which may be connected to the same device bus or another device bus.

The computer system may be coupled via bus to a display (614), such as a cathode ray tube (CRT), liquid crystal display (LCD), voice synthesis hardware and/or software, etc., for displaying and/or providing information to a computer user. The display may be controlled by a display or graphics card. The computer system includes input devices, such as a keyboard (616) and a cursor control (618), for communicating information and command selections to processor (606). Such command selections can be implemented via voice recognition hardware and/or software functioning as the input devices (616). The cursor control (618), for example, is a mouse, a trackball, cursor direction keys, touch screen display, optical character recognition hardware and/or software, etc., for communicating direction information and command selections to processor (606) and for controlling cursor movement on the display (614). In addition, a printer (not shown) may provide printed listings of the data structures, information, etc., or any other data stored and/or generated by the computer system.

The computer system performs a portion or all of the processing steps of the invention in response to processor executing one or more sequences of one or more instructions contained in a memory, such as the main memory. Such instructions may be read into the main memory from another computer readable medium, such as storage device. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The computer system also includes a communication interface coupled to bus. The communication interface (620) provides a two-way data communication coupling to a network link (622) that may be connected to, for example, a local network (624). For example, the communication interface (620) may be a network interface card to attach to any packet switched local area network (LAN). As another example, the communication interface (620) may be an asymmetrical digital subscriber line (ADSL) card, an integrated services digital network (ISDN) card or a modem to provide a data communication connection to a corresponding type of telephone line. Wireless links may also be implemented via the communication interface (620). In any such implementation, the communication interface (620) sends and receives electrical, electromagnetic or optical signals that carry digital data streams representing various types of information.

Network link (622) typically provides data communication through one or more networks to other data devices. For example, the network link may provide a connection to a computer (626) through local network (624) (e.g., a LAN) or through equipment operated by a service provider, which provides communication services through a communications network (628). In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit notifications and receive data, including program code, through the network(s), the network link and the communication interface.

It should be understood, that the invention is not necessarily limited to the specific process, arrangement, materials and components shown and described above, but may be susceptible to numerous variations within the scope of the invention.

What is claimed is:

1. A method for automatic error analysis of a plurality of applications on at least one computer system, comprising:
maintaining at least one dependency structure of the applications running on the at least one computer system;
maintaining correlation information between error symptoms that appear in the at least one computer system and errors that causes the error symptoms; and
analyzing a problem that includes at least one of the error symptoms when at least one error occurs that causes the problem.

2. The method of claim 1, wherein the maintaining a correlation information comprises:
updating the correlation information when a supported application is one of installed, updated and uninstalled; and
building up correlation rules using occurred errors and the dependency structure.

3. The method of claim 1, wherein the analyzing comprises:
detecting the appearance of the problem; and
generating an error symptom tree based on the dependency structure when a predetermined number of errors are logged to determine the problem.

4. The method of claim 3, further comprising building recovery steps bottom-up from a root problem identified from the error symptom tree, wherein the recovery steps are from one of the automatic scripts, manual instructions and a combination of the automatic scripts and manual instructions.

5. The method of claim 1, further comprising utilizing a centralized knowledge base for runtime error handling and problem resolution.

6. The method of claim 5, wherein the utilizing comprises:
sharing correlation entries of an application of the at least one computer system in the knowledge base;
adding new learned correlation rules of a system into the knowledge base; and
adding new correlation rules in the knowledge base to a system's error correlation information.

7. A computer program product for automatic error analysis of a plurality of applications on at least one computer system, the computer program product comprising:
a computer usable medium having computer usable program code embodied therewith, the computer usable program code comprising:
instructions to maintain at least one dependency structure of the applications running on the at least one computer system;
instructions to maintain correlation information between error symptoms that appear in the at least one computer system and errors that causes the error symptoms; and
instructions to analyze a problem that includes at least one of the error symptoms when at least one error occurs that causes the problem.

8. The computer program product of claim 7, wherein the instructions to maintain a correlation information comprises:
instructions to update the correlation information when a supported application is one of the installed, updated and uninstalled; and
instructions to build up correlation rules using occurred errors and the dependency structure.

9. The computer program product of claim 7, wherein the instructions to analyze comprises:
instructions to detect the appearance of a problem; and
instructions to generate an error symptom tree based on the dependency structure when a predetermined number of errors are logged to determine the problem.

10. The computer program product of claim 9, further comprising instructions to build recovery steps bottom-up from a root problem identified from the error symptom tree, wherein the recovery steps are from one of the automatic scripts, manual instructions and a combination of the automatic scripts and manual instructions.

11. The computer program product of claim 7, further comprising instructions to utilize a centralized knowledge base for runtime error handling and problem resolution.

12. The computer program product of claim 11, wherein the instructions to utilize comprises:
instructions to share correlation entries of an application of at least one computer system in the knowledge base;
instructions to add new learned correlation rules of a system into the knowledge base; and
instructions to add new correlation rules in the knowledge base to a system's error correlation information.

13. A computer system comprising:
a processor;
a memory operatively coupled with the processor;
a storage device operatively coupled with the processor and the memory; and
a computer program product for automatic error analysis of a plurality of applications on at least one computer system, the computer program product comprising:
a computer usable medium having computer usable program code embodied therewith, the computer usable program code comprising:
instructions to maintain at least one dependency structure of the applications running on the at least one computer system;
instructions to maintain correlation information between error symptoms that appear in the at least one computer system and errors that causes the error symptoms; and
instructions to analyze a problem that includes at least one of the error symptoms when at least one error occurs that causes the problem.

14. The computer system of claim 13, wherein the instructions to maintain a correlation information comprises:
instructions to update the correlation information when a supported application is one of the installed, updated and uninstalled; and
instructions to build up correlation rules using occurred errors and the dependency structure.

15. The computer program product of claim 13, wherein the instructions to analyze comprises:
instructions to detect the appearance of a problem; and
instructions to generate an error symptom tree based on the dependency structure when a predetermined number of errors are logged to determine the problem.

16. The computer system of claim 15, further comprising instructions to build recovery steps bottom-up from a root problem identified from the error symptom tree, wherein the recovery steps are from one of the automatic scripts, manual instructions and a combination of the automatic scripts and manual instructions.

17. The computer system of claim 13, further comprising instructions to utilize a centralized knowledge base for runtime error handling and problem resolution.

18. The computer system of claim 17, wherein the instructions to utilize comprises:
instructions to share correlation entries of an application of the at least one computer system in the knowledge base;
instructions to add new learned correlation rules of a system into the knowledge base; and
instructions to add new correlation rules in the knowledge base to a system's error correlation information.
